(19) United States
(12) Patent Application Publication
(10) Pub. No.: US 2025/0035805 A1
(43) Pub. Date: Jan. 30, 2025

(54) VSP-BASED DEPTH DOMAIN SEISMIC PROFILE HORIZON CALIBRATION METHOD AND APPARATUS

(71) Applicants: China National Petroleum Corporation, Beijing (CN); BGP Inc., China National Petroleum Corporation, Hebei (CN)

(72) Inventors: Yanpeng LI, Hebei (CN); Yuanzhong CHEN, Hebei (CN); Jing WANG, Hebei (CN); Qihu JIN, Hebei (CN)

(73) Assignees: China National Petroleum Corporation, Beijing (CN); BGP Inc., China National Petroleum Corporation, Hebei (CN)

(21) Appl. No.: 18/697,133

(22) PCT Filed: Jun. 30, 2022
(86) PCT No.: PCT/CN2022/102935

§ 371 Date: Mar. 29, 2024

(30) Foreign Application Priority Data
Dec. 30, 2021 (CN) 202111654323.9

(51) Int. Cl. G01V 1/50

(52) U.S. Cl. CPC G01V 1/50; G01V 2210/161

(57) ABSTRACT

A VSP-based depth domain seismic profile horizon calibration method includes steps: obtaining VSP wavefield data of a depth domain (S10); determining first arrival time information on the basis of the VSP wavefield data (S20); processing the VSP wavefield data on the basis of a preset filtering method and the first arrival time information to obtain upgoing wave data (S30); generating a zero offset profile of the depth domain on the basis of the upgoing wave data (S40); and calibrating, on the basis of the zero offset profile, a depth-domain profile to be calibrated, so as to generate a corresponding calibration result (S50). Also provided are a VSP-based depth domain seismic profile horizon calibration apparatus and a computer-readable storage medium.

### CROSS REFERENCE TO RELATED APPLICATIONS

This application claims priority to Chinese Application No. 202111654323.9, filed on Dec. 30, 2021, entitled “VSP-BASED DEPTH DOMAIN SEISMIC PROFILE HORIZON CALIBRATION METHOD AND APPARATUS”, which is specifically and entirely incorporated by reference.

### FIELD OF THE INVENTION

The present disclosure relates to the technical field of seismic exploration data interpretation, in particular to a VSP-based depth domain seismic profile horizon calibration method, a VSP-based depth domain seismic profile horizon calibration apparatus and a computer readable storage medium.

### BACKGROUND OF THE INVENTION

With the continuous development of science and technology, more and more technologies have been applied to the technical field of seismic exploration, such as a borehole seismic exploration technology based on a vertical seismic profile (VSP). This technology accurately obtains seismic wavefields in a depth domain by placing a plurality of sensors in a well.

In the application process, since the sensors are placed in the well to receive data, which avoids the influence of near surface, and has significant advantages such as a high signal-to-noise ratio, a rich wavefield, and an accurate time-depth relationship, so VSPs are widely used to obtain formation velocity and other information, and also for accurate horizon calibration of surface seismic profiles.

However, in the actual application process, existing horizon calibration is generally carried out on a time domain profile, with the gradual application and promotion of a depth migration technology, people put forward higher requirements for the accuracy of depth calibration, but an existing technology often adopts a method of performing time-depth conversion based on a vertical seismic corridor stack profile, or utilizes a depth domain synthetic record from well-logging data for calibration, its calibration accuracy cannot meet the needs of current technicians.

### SUMMARY OF THE INVENTION

In order to overcome the above technical problems in the prior art, an embodiment of the present disclosure provides a VSP-based depth domain seismic profile horizon calibration method. Upgoing wave data in seismic data is extracted by analyzing the seismic data of the depth domain, accurate reflection information of the depth domain in a formation is determined according to the upgoing wave data, and a profile of the depth domain is further accurately calibrated, so that calibration accuracy is improved, and actual needs are met.

In order to achieve the above aims, the embodiment of the present disclosure provides a VSP-based depth domain seismic profile horizon calibration method. The method includes: obtaining VSP wavefield data of a depth domain; determining first arrival time information on the basis of the VSP wavefield data; processing the VSP wavefield data on the basis of a preset filtering method and the first arrival time information to obtain upgoing wave data; generating a zero offset profile of the depth domain on the basis of the upgoing wave data; and calibrating, on the basis of the zero offset profile, a depth-domain profile to be calibrated, so as to generate a corresponding calibration result.

Optionally, the preset filtering method includes a median filtering method and a mean filtering method, and processing the VSP wavefield data on the basis of a preset filtering method and the first arrival time information to obtain upgoing wave data includes: processing the VSP wavefield data on the basis of the median filtering method or the mean filtering method to determine a corresponding upgoing wave and downgoing wave; determining a first time window on the basis of the first arrival time information; processing the downgoing wave on the basis of the first time window to obtain a downgoing wavelet; executing deconvolution processing on the upgoing wave in data after wavefield separation on the basis of the downgoing wavelet to obtain deconvoluted data; and executing amplitude compensation processing on the deconvoluted data to obtain the upgoing wave data.

Optionally, generating the zero offset profile of the depth domain on the basis of the upgoing wave data includes: determining upgoing wave amplitude information of the depth domain on the basis of the upgoing wave data; and processing the upgoing wave amplitude information on the basis of a preset multichannel filtering method to obtain the zero offset profile of the depth domain.

Optionally, determining the upgoing wave amplitude information of the depth domain on the basis of the upgoing wave data includes: determining a plurality of preset output depth positions in the depth domain; determining a second time window on the basis of the first arrival time information; and processing the upgoing wave data on the plurality of preset output depth positions on the basis of the second time window to obtain the upgoing wave amplitude information.

Optionally, processing the upgoing wave amplitude information on the basis of the preset multichannel filtering method to obtain the zero offset profile of the depth domain includes: extracting the upgoing wave amplitude information to obtain a plurality of corresponding depth-domain data, wherein the upgoing wave amplitude information is in one-to-one correspondence to the plurality of preset output depth positions; and processing the plurality of depth domain data on the basis of the preset multichannel filtering method to obtain the zero offset profile of the depth domain.

Optionally, calibrating, on the basis of the zero offset profile, a depth-domain profile to be calibrated, so as to generate a corresponding calibration result includes: determining the to-be-calibrated depth-domain profile; determining a depth error between the zero offset profile and the to-be-calibrated depth-domain profile and a corresponding relationship of reflection characteristics; and analyzing the depth error and the corresponding relationship of the reflection characteristics to generate the corresponding calibration result, wherein the calibration result includes depth accuracy evaluation information of the profile of the depth domain and corresponding correction suggestion information.

Correspondingly, the present disclosure further provides a VSP-based depth domain seismic profile horizon calibration apparatus, and the apparatus includes: a borehole seismic wavefield obtaining unit, configured to obtain VSP wavefield data of a depth domain; a first arrival time obtaining unit, configured to determine first arrival time information on the basis of the VSP wavefield data; a preprocessing unit, configured to process the VSP wavefield data on the basis of a preset filtering method and the first arrival time information to obtain upgoing wave data; a profile information generating unit, configured to generate a zero offset profile of the depth domain on the basis of the upgoing wave data; and a calibrating unit, configured to calibrate, on the basis of the zero offset profile, a depth-domain profile to be calibrated, so as to generate a corresponding calibration result includes:

Optionally, the preset filtering method includes a median filtering method and a mean filtering method, and the preprocessing unit includes: a wavefield separating module, configured to process the VSP wavefield data on the basis of the median filtering method or the mean filtering method to determine a corresponding upgoing wave and downgoing wave; a first time window determining module, configured to determine a first time window on the basis of the first arrival time information; a wavelet obtaining module, configured to process the downgoing wave on the basis of the first time window to obtain a downgoing wavelet; a wavelet deconvolution module, configured to execute deconvolution processing on the upgoing wave in data after wavefield separation on the basis of the downgoing wavelet to obtain deconvoluted data; and an amplitude compensating module, configured to execute amplitude compensation processing on the deconvoluted data to obtain the upgoing wave data.

Optionally, the profile information generating unit includes: a depth domain amplitude value extracting module, configured to determine upgoing wave amplitude information of the depth domain on the basis of the upgoing wave data; and a filtering module, configured to process the upgoing wave amplitude information on the basis of a preset multichannel filtering method to obtain the zero offset profile of the depth domain.

Optionally, the depth domain amplitude value extracting module is specifically configured to: determine a plurality of preset output depth positions in the depth domain; determine a second time window on the basis of the first arrival time information; and process the upgoing wave data on the plurality of preset output depth positions on the basis of the second time window to obtain the upgoing wave amplitude information.

Optionally, the filtering module is specifically configured to: extracting the upgoing wave amplitude information to obtain a plurality of corresponding depth-domain data, wherein the upgoing wave amplitude information is in one-to-one correspondence to the plurality of preset output depth positions; and processing the plurality of depth domain data on the basis of the preset multichannel filtering method to obtain the zero offset profile of the depth domain.

Optionally, the calibrating unit is specifically configured to: determine the to-be-calibrated depth-domain profile; determine a depth error between the zero offset profile and the to-be-calibrated depth-domain profile and a corresponding relationship of reflection characteristics; and analyzing the depth error and the corresponding relationship of the reflection characteristics to generate the corresponding calibration result, wherein the calibration result includes depth accuracy evaluation information of the depth-domain profile and corresponding correction suggestion information.

On the other hand, the present disclosure further provides a computer readable storage medium, storing a computer program, and the program, when executed by a processor, implements the VSP-based depth domain seismic profile horizon calibration method provided by the present disclosure.

Through the technical solution provided by the present disclosure, the present disclosure at least has the following technical effects:

the accurate upgoing wave data is extracted from the seismic data by performing seismic data acquisition on the borehole depth domain, performing first arrival picking on the seismic data and performing wavefield separation and deconvolution, corresponding formation reflection information is determined according to the upgoing wave data so as to obtain a zero offset profile of the depth domain, therefore, the depth-domain profile is accurately calibrated, an error of a time-domain corridor in time-depth conversion in prior art is effectively overcome, and the calibration accuracy of the depth domain is improved.

Other features and advantages of the embodiments of the present disclosure will be illustrated in detail in the following part of specific implementations.

### BRIEF DESCRIPTION OF DRAWINGS

The accompanying drawings are used to provide further understanding of embodiments of the present disclosure, and form part of the specification, and are used to explain the embodiments of the present disclosure together with the following specific implementations, but they do not constitute a limitation to the embodiments of the present disclosure. In the accompanying drawings:

FIG. 1 is a flow diagram of a specific implementation of a VSP-based depth domain seismic profile horizon calibration method provided by an embodiment of the present disclosure.

FIG. 2 is a schematic diagram of VSP wavefield data in a VSP-based depth domain seismic profile horizon calibration method provided by an embodiment of the present disclosure.

FIG. 3 is a flow diagram of a specific implementation of obtaining upgoing wave data in a VSP-based depth domain seismic profile horizon calibration method provided by an embodiment of the present disclosure.

FIG. 4 is a schematic diagram of upgoing wave data in a VSP-based depth domain seismic profile horizon calibration method provided by an embodiment of the present disclosure.

FIG. 5 is schematic contrast diagram of synthetic records (three in the middle) with different resolutions in a depth domain obtained by a VSP depth-domain zero offset profile (right) and well-logging data (left) in a VSP-based depth domain seismic profile horizon calibration method provided by an embodiment of the present disclosure.

FIG. 6 is a flow diagram of a specific implementation of generating a calibration result in a VSP-based depth domain seismic profile horizon calibration method provided by an embodiment of the present disclosure.

FIG. 7 is a schematic contrast diagram of embedding a well-logging depth-domain synthetic record and a VSP depth-domain zero offset profile into a surface seismic profile in a VSP-based depth domain seismic profile horizon calibration method provided by an embodiment of the present disclosure.

FIG. 8 is a schematic structural diagram of a VSP-based depth domain seismic profile horizon calibration apparatus provided by an embodiment of the present disclosure.

### DETAILED DESCRIPTION OF THE EMBODIMENTS

The specific implementations of embodiments of the present disclosure are illustrated in detail below in combination with the accompanying drawings. It should be understood that the specific implementations described herein are merely used to illustrate and explain the embodiments of the present disclosure and are not used to limit the embodiments of the present disclosure.

Terms “system” and “network” in the embodiments of the present disclosure may be used interchangeably. “A plurality of” means two or more, and in view of this, “a plurality of” may also be understood as “at least two” in the embodiments of the present disclosure. “And/or” describes an association relationship of associated objects, indicating that there may be three kinds of relationships, for example, A and/or B may indicate that: A exists alone, both A and B exist, and B exists alone. In addition, the character “/”, unless otherwise specified, generally indicates that the associated objects before and after the character is in an “or” relationship. In addition, it needs to be understood that in the description of the embodiments of the present disclosure, words “first”, “second”, etc. are merely for the purpose of distinguishing and are not to be understood as indicating or suggesting relative importance, nor as indicating or suggesting an order.

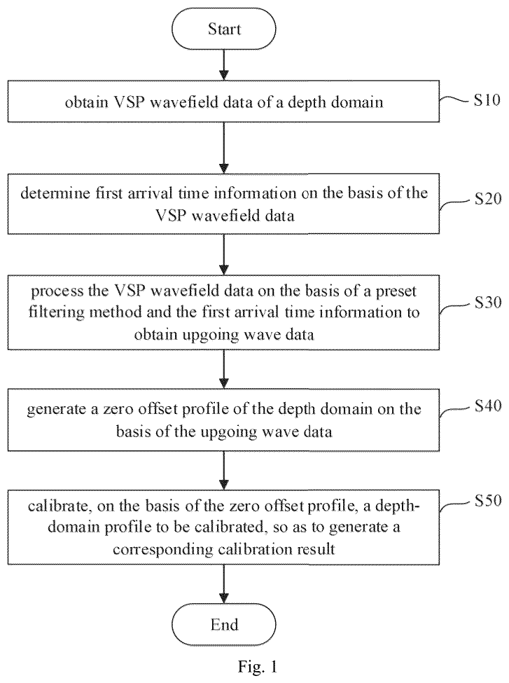

Please referring to FIG. 1, an embodiment of the present disclosure provides a VSP-based depth domain seismic profile horizon calibration method, including:
S10) obtaining VSP wavefield data of a depth domain;
S20) determining first arrival time information on the basis of the VSP wavefield data;
S30) processing the VSP wavefield data on the basis of a preset filtering method and the first arrival time information to obtain upgoing wave data;
S40) generating a zero offset profile of the depth domain on the basis of the upgoing wave data; and
S50) calibrating, on the basis of the zero offset profile, a depth-domain profile to be calibrated, so as to generate a corresponding calibration result.

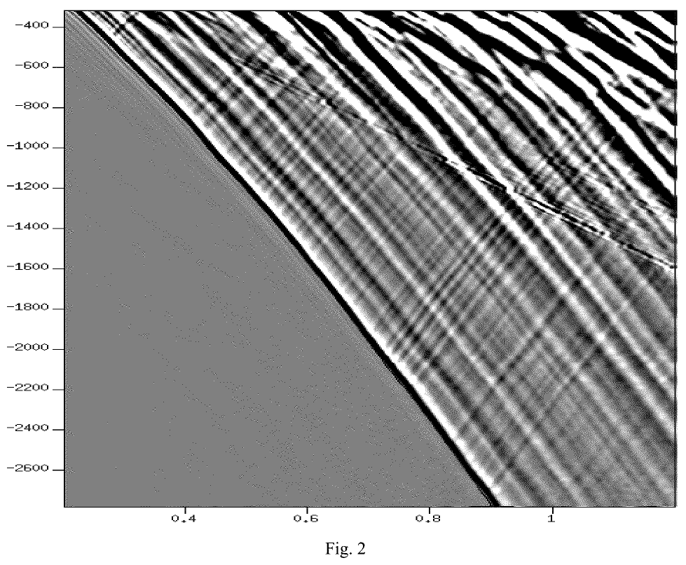

In a possible implementation, in order to accurately calibrate a formation of the depth domain, firstly, borehole seismic wavefield data in the depth domain is obtained, and data detected by a borehole acquisition instrument is transmitted and collected by arranging the borehole acquisition instrument in the formation of the depth domain and receiving and connecting the borehole acquisition instrument through a geophone or optical cable reception, and then, the corresponding seismic wavefield data is collected in the formation of the depth domain by using an excitation of an explosive seismic source or a vibroseis on the surface or in a well. Then, existing first arrival picking methods are used to analyze the above seismic wave data to obtain the corresponding first arrival time information, the existing first arrival picking method include but are not limited to a maximum energy method, a Short Term Average/Long Term Average (STA/LTA) method, a cross-correlation method, a phase tracking method and so on. FIG. 2 is a schematic diagram of VSP wavefield data provided by an embodiment of the present disclosure, and the corresponding first arrival time information may be obtained through the seismic wave data.

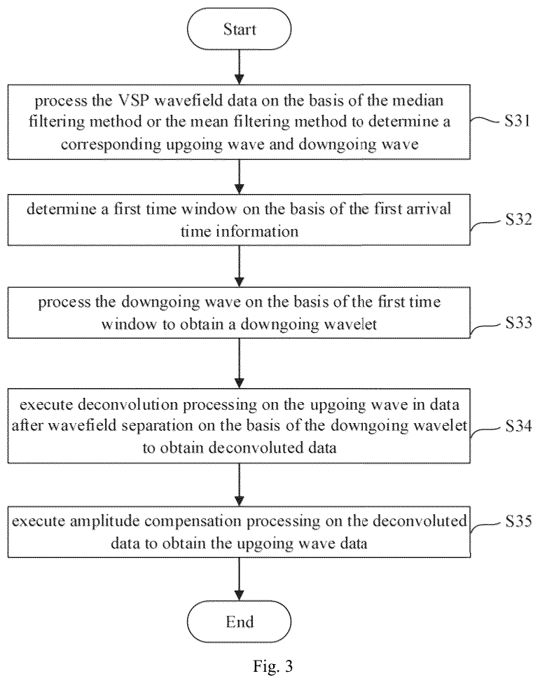

At this time, the seismic wave data is further analyzed and processed. Please referring to FIG. 3, in the embodiment of the present disclosure, the preset filtering method includes a median filtering method and a mean filtering method, and processing the VSP wavefield data on the basis of the preset filtering method and the first arrival time information to obtain the upgoing wave data includes:
S31) processing the VSP wavefield data on the basis of the median filtering method or the mean filtering method to determine a corresponding upgoing wave and downgoing wave;
S32) determining a first time window on the basis of the first arrival time information;
S33) processing the downgoing wave on the basis of the first time window to obtain a downgoing wavelet;
S34) executing deconvolution processing on the upgoing wave in data after wavefield separation on the basis of the downgoing wavelet to obtain deconvoluted data; and
S35) executing amplitude compensation processing on the deconvoluted data to obtain the upgoing wave data.

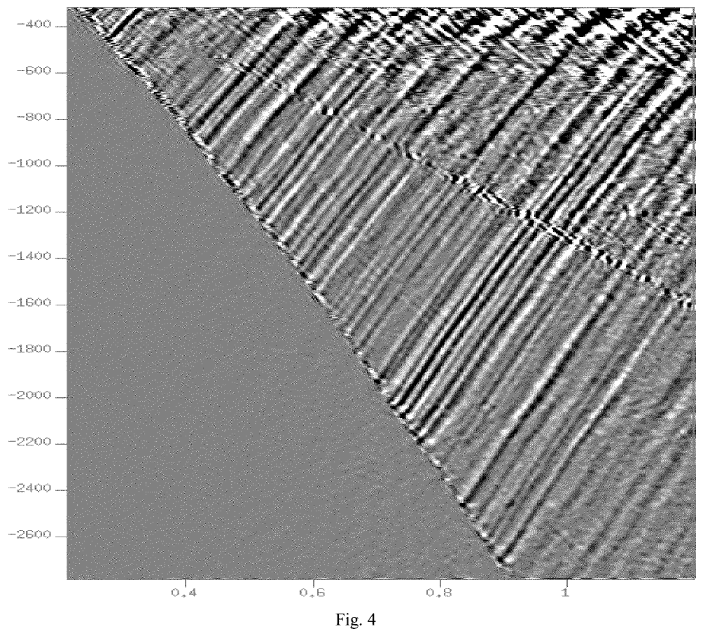

In a possible implementation, firstly, the above seismic wave data is predicted according to the median filtering method or the mean filtering method, the corresponding upgoing wave and downgoing wave are determined, then, the first time window is determined according to the first arrival time information, corresponding data are intercepted in the downgoing wave through the first time window to obtain the corresponding downgoing wavelet, at this time, deconvolution processing is further performed on the upgoing wave in the data after wavefield separation according to the above downgoing wavelet to suppress the influence of multiple waves and obtain the corresponding deconvoluted data, and amplitude compensation processing is executed on the above deconvoluted data so as to remove the amplitude change influence caused by spherical spreading and obtain upgoing wavefield data. Please referring to FIG. 4 which is a schematic diagram of upgoing wave data provided by an embodiment of the present disclosure.

In the embodiment of the present disclosure, corresponding filtering and denoising processing are performed on both the obtained upgoing wave and downgoing wave of the seismic wave data, so that the more accurate upgoing wave data is obtained, accurate data support is provided for subsequent analysis of relevant information of the depth domain, and accuracy of subsequent depth-domain formation calibration is improved effectively.

In the embodiment of the present disclosure, generating the zero offset profile of the depth domain on the basis of the upgoing wave data includes: determining upgoing wave amplitude information of the depth domain on the basis of the upgoing wave data; and processing the upgoing wave amplitude information on the basis of a preset multichannel filtering method to obtain the zero offset profile of the depth domain.

In a possible implementation, after the above upgoing wave data is obtained, the upgoing wave amplitude information of the depth domain is further determined. And determining the upgoing wave amplitude information of the depth domain on the basis of the upgoing wave data includes: determining a plurality of preset output depth positions in the depth domain; determining a second time window on the basis of the first arrival time information; and processing the upgoing wave data on the plurality of preset output depth positions on the basis of the second time window to obtain the upgoing wave amplitude information.

After an upgoing wavefield is obtained, for each output depth position i in m depths of upgoing wave records, an upgoing wave amplitude Aᵢⱼ is further extracted by taking a short time window downward along the first arrival time of the upgoing wavefield, wherein j is a trace number relative to a depth position above the depth position i. According to a size of a depth interval of an input seismic trace and non-uniformity of a true vertical depth under an inclined well condition, an output depth may be deeply encrypted or interpolated to obtain a higher and more uniform depth sampling density.

Furthermore, in the embodiment of the present disclosure, processing the upgoing wave amplitude information on the basis of the preset multichannel filtering method to obtain the zero offset profile of the depth domain includes: extracting the upgoing wave amplitude information to obtain a plurality of corresponding depth-domain data, wherein the upgoing wave amplitude information is in one-to-one correspondence to the plurality of preset output depth positions; and processing the plurality of depth-domain data on the basis of the preset multichannel filtering method to obtain the zero offset profile of the depth domain.

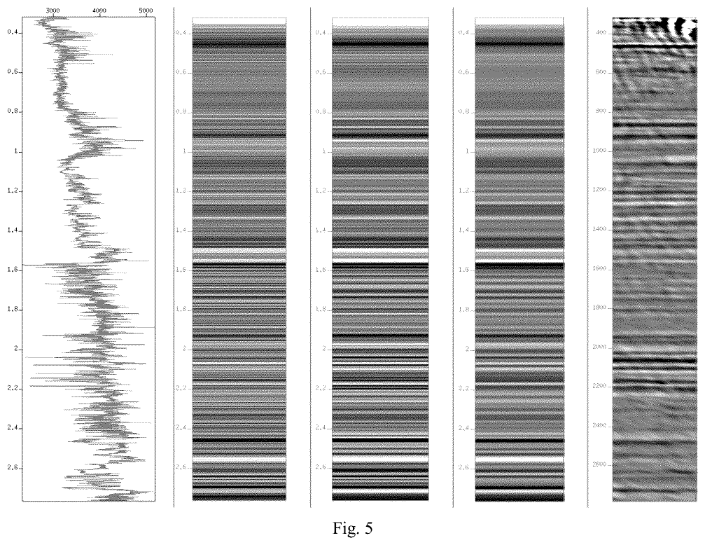

In a possible implementation, after the upgoing wave amplitude information is obtained, n depth-domain record traces corresponding to m depth points are generated through the upgoing wave amplitude information, the depth-domain record traces are further processed through the preset multichannel filtering method so as to improve a signal to noise ratio, for example, the preset multichannel filtering method is a median filtering method or other multichannel filtering methods, and a corresponding zero offset profile of the depth domain is obtained. At this time, a calibration result for the current formation of the depth domain is generated according to the profile information, please referring to FIG. 5 which is a schematic contrast diagram of synthetic records (three in the middle) with different resolutions in a depth domain obtained by a VSP depth-domain zero offset profile (right) and well-logging data (left) provided by an embodiment of the present disclosure.

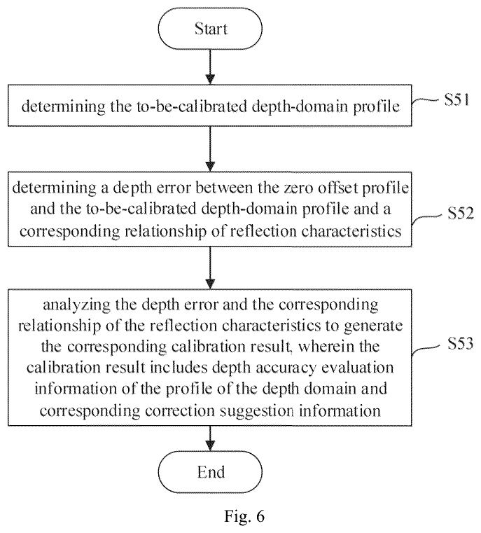

Please referring to FIG. 6, in the embodiment of the present disclosure, calibrating, on the basis of the zero offset profile, a depth-domain profile to be calibrated, so as to generate a corresponding calibration result includes:
S51) determining the to-be-calibrated depth-domain profile;
S52) determining a depth error between the zero offset profile and the to-be-calibrated depth-domain profile and a corresponding relationship of reflection characteristics; and
S53) analyzing the depth error and the corresponding relationship of the reflection characteristics to generate the corresponding calibration result, wherein the calibration result includes depth accuracy evaluation information of the profile of the depth domain and corresponding correction suggestion information.

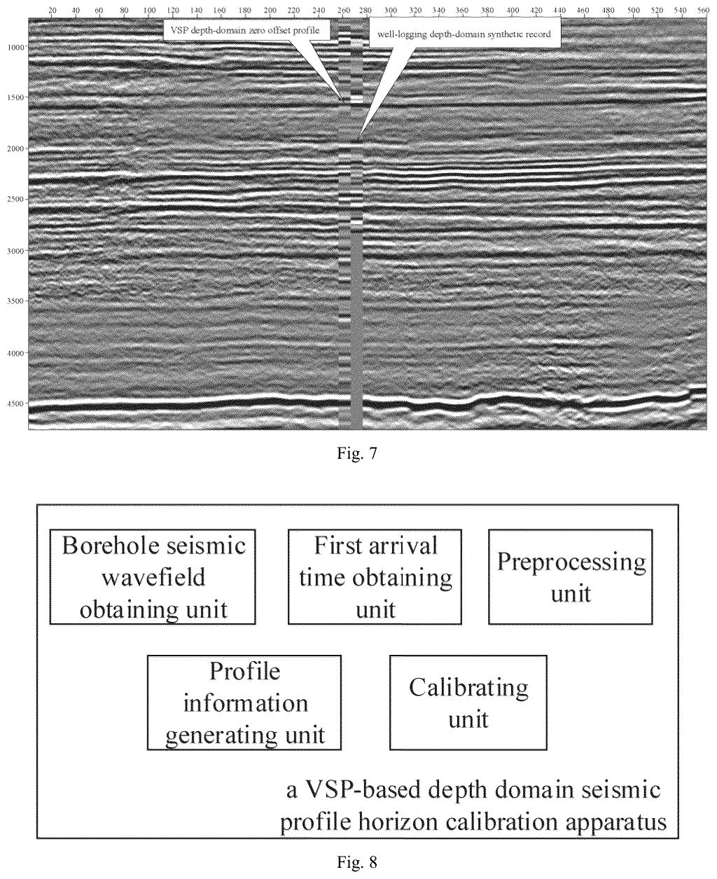

In a possible implementation, firstly, the to-be-calibrated depth-domain profile is determined, then, the zero offset profile of the depth domain is embedded in the to-be-calibrated depth-domain profile (see FIG. 7), so that a corresponding relationship of reflection characteristics of shallow, middle and deep horizons between the zero offset profile and the to-be-calibrated depth-domain profile and the depth error are analyzed, and depth accuracy evaluation information and depth correction suggestion information of the corresponding depth-domain profile are obtained.

In the embodiment of the present disclosure, formation reflection information is obtained by travel time along each depth upgoing wave of the depth domain, the zero offset depth profile of VSP is obtained, the to-be-calibrated depth profile is accurately calibrated, an error of a time-domain corridor in time-depth conversion in the prior art is effectively overcome, depth calibration accuracy is obviously improved, accurate data support is provided for subsequent interpretation of a reservoir depth domain, the depth domain interpretation accuracy is improved, and actual needs of technicists are met.

An apparatus for calibrating a formation of a depth domain provided by an embodiment of the present disclosure is illustrated below in combination with accompanying drawings.

Please referring to FIG. 8, based on the same inventive conception, an embodiment of the present disclosure provides a VSP-based depth domain seismic profile horizon calibration apparatus. The apparatus includes: a borehole seismic wavefield obtaining unit, configured to obtain VSP wavefield data of a depth domain; a first arrival time obtaining unit, configured to determine first arrival time information on the basis of the VSP wavefield data; a preprocessing unit, configured to process the VSP wavefield data on the basis of a preset filtering method and the first arrival time information to obtain upgoing wave data; a profile information generating unit, configured to generate a zero offset profile of the depth domain on the basis of the upgoing wave data; and a calibrating unit, configured to calibrate, on the basis of the zero offset profile, a depth-domain profile to be calibrated, so as to generate a corresponding calibration result.

In the embodiment of the present disclosure, the preset filtering method includes a median filtering method and a mean filtering method, and the preprocessing unit includes: a wavefield separating module, configured to process the VSP wavefield data on the basis of the median filtering method or the mean filtering method to determine a corresponding upgoing wave and downgoing wave; a first time window determining module, configured to determine a first time window on the basis of the first arrival time information; a wavelet obtaining module, configured to process the downgoing wave on the basis of the first time window to obtain a downgoing wavelet; a wavelet deconvolution module, configured to execute deconvolution processing on the upgoing wave in data after wavefield separation on the basis of the downgoing wavelet to obtain deconvoluted data; and an amplitude compensating module, configured to execute amplitude compensation processing on the deconvoluted data to obtain the upgoing wave data.

In the embodiment of the present disclosure, the profile information generating unit includes: a depth domain amplitude value extracting module, configured to determine upgoing wave amplitude information of the depth domain on the basis of the upgoing wave data; and a filtering module, configured to process the upgoing wave amplitude information on the basis of a preset multichannel filtering method to obtain the zero offset profile of the depth domain.

In the embodiment of the present disclosure, the depth domain amplitude value extracting module is specifically configured to: determine a plurality of preset output depth positions in the depth domain; determine a second time window on the basis of the first arrival time information; and process the upgoing wave data on the plurality of preset output depth positions on the basis of the second time window to obtain the upgoing wave amplitude information.

In the embodiment of the present disclosure, the filtering module is specifically configured to: analyze the upgoing wave amplitude information to obtain a plurality of corresponding depth-domain data, wherein the upgoing wave amplitude information is in one-to-one correspondence to the plurality of preset output depth positions; and process the plurality of depth-domain data on the basis of the preset multichannel filtering method to obtain the zero offset profile of the depth domain.

In the embodiment of the present disclosure, the calibrating unit is specifically configured to: determine the to-be-calibrated depth domain profile; determine a depth error between the zero offset profile and the to-be-calibrated depth-domain profile and a corresponding relationship of reflection characteristics; and analyze the depth error and the corresponding relationship of the reflection characteristics to generate the corresponding calibration result, wherein the calibration result includes depth accuracy evaluation information of the depth-domain profile and corresponding correction suggestion information.

Furthermore, an embodiment of the present disclosure further provides a computer readable storage medium, storing a computer program, and the program, when executed by a processor, implements the VSP-based depth domain seismic profile horizon calibration method of the present disclosure.

Optional implementations of the embodiments of the present disclosure are described in detail above in combination with the accompanying drawings, however, the embodiments of the present disclosure are not limited to specific details of the above implementations, a variety of simple variations may be made to the technical solutions of the embodiments of the present disclosure within the scope of the technical conception of the embodiments of the present disclosure, and these simple variations fall within the protection scope of the embodiments of the present disclosure.

In addition, it should be noted that the specific technical features described in the above specific implementations may be combined in any suitable mode in the case of not contradiction. In order to avoid unnecessary duplication, the embodiments of the present disclosure will not separately specify various possible combinations.

Those skilled in the art may understand that the implementation of all or part of steps in the methods of the above embodiments may be completed by instructing, through a program, relevant hardware, the program is stored in a storage medium, and includes a plurality of instructions to cause a single chip microcomputer, a chip, or a processor to execute all or part of the steps of the methods described in the various embodiments of the present application. The aforementioned storage mediums include: a USB flash disk, a mobile hard disk, a read-only memory (ROM), a random access memory (RAM), a diskette or an optical disk and various other media that may store program codes.

In addition, any combination may also be made between various different implementations of the embodiments of the present disclosure, and as long as it does not violate the concept of the embodiments of the present disclosure, it shall also be regarded as the content disclosed in the embodiments of the present disclosure.

1. A VSP-based depth domain seismic profile horizon calibration method, comprising:
obtaining vertical seismic profile (VSP) wavefield data of a depth domain from a borehole acquisition instrument;
determining first arrival time information on the basis of the VSP wavefield data;
processing the VSP wavefield data on the basis of a preset filtering method and the first arrival time information to obtain upgoing wave data;
generating a zero offset profile of the depth domain on the basis of the upgoing wave data; and
calibrating, on the basis of the zero offset profile, a depth-domain profile to be calibrated, so as to generate a corresponding calibration result, wherein the calibration result comprises depth accuracy evaluation information of the profile of the depth domain and corresponding correction suggestion information.

2. The method according to claim 1, wherein the preset filtering method comprises a median filtering method and a mean filtering method; and
processing the VSP wavefield data on the basis of a preset filtering method and the first arrival time information to obtain upgoing wave data comprises:
processing the VSP wavefield data on the basis of the median filtering method or the mean filtering method to determine a corresponding upgoing wave and downgoing wave;
determining a first time window on the basis of the first arrival time information;
processing the downgoing wave on the basis of the first time window to obtain a downgoing wavelet;
executing deconvolution processing on the upgoing wave in data after wavefield separation on the basis of the downgoing wavelet to obtain deconvoluted data; and
executing amplitude compensation processing on the deconvoluted data to obtain the upgoing wave data.

3. The method according to claim 1, wherein generating the zero offset profile of the depth domain on the basis of the upgoing wave data comprises:
determining upgoing wave amplitude information of the depth domain on the basis of the upgoing wave data; and
processing the upgoing wave amplitude information on the basis of a preset multichannel filtering method to obtain the zero offset profile of the depth domain.

4. The method according to claim 3, wherein determining the upgoing wave amplitude information of the depth domain on the basis of the upgoing wave data comprises:
determining a plurality of preset output depth positions in the depth domain;
determining a second time window on the basis of the first arrival time information; and
processing the upgoing wave data on the plurality of preset output depth positions on the basis of the second time window to obtain the upgoing wave amplitude information.

5. The method according to claim 4, wherein processing the upgoing wave amplitude information on the basis of the preset multichannel filtering method to obtain the zero offset profile of the depth domain comprises:
extracting the upgoing wave amplitude information to obtain a plurality of corresponding depth-domain data, wherein the upgoing wave amplitude information is in one-to-one correspondence to the plurality of preset output depth positions; and
processing the plurality of depth-domain data on the basis of the preset multichannel filtering method to obtain the zero offset profile of the depth domain.

6. The method according to claim 1, wherein calibrating, on the basis of the zero offset profile, a depth-domain profile to be calibrated, so as to generate a corresponding calibration result, comprises:
determining the to-be-calibrated depth-domain profile;
determining a depth error between the zero offset profile and the to-be-calibrated depth-domain profile and a corresponding relationship of reflection characteristics; and
analyzing the depth error and the corresponding relationship of the reflection characteristics to generate the corresponding calibration result.

7. A VSP-based depth domain seismic profile horizon calibration apparatus, comprising:
a borehole seismic wavefield obtaining unit, configured to obtain VSP wavefield data of a depth domain from a borehole acquisition instrument;
a first arrival time obtaining unit, configured to determine first arrival time information on the basis of the VSP wavefield data;
a preprocessing unit, configured to process the VSP wavefield data on the basis of a preset filtering method and the first arrival time information to obtain upgoing wave data;
a profile information generating unit, configured to generate a zero offset profile of the depth domain on the basis of the upgoing wave data; and
a calibrating unit, configured to calibrate, on the basis of the zero offset profile, a depth-domain profile to be calibrated, so as to generate a corresponding calibration result, wherein the calibration result comprises depth accuracy evaluation information of the depth-domain profile and corresponding correction suggestion information.

8. The apparatus according to claim 7, wherein the preset filtering method comprises a median filtering method and a mean filtering method, and the preprocessing unit comprises:
a wavefield separating module, configured to process the VSP wavefield data on the basis of the median filtering method or the mean filtering method to determine a corresponding upgoing wave and downgoing wave;
a first time window determining module, configured to determine a first time window on the basis of the first arrival time information;
a wavelet obtaining module, configured to process the downgoing wave on the basis of the first time window to obtain a downgoing wavelet;
a wavelet deconvolution module, configured to executing deconvolution processing on the upgoing wave in data after wavefield separation on the basis of the downgoing wavelet to obtain deconvoluted data; and
an amplitude compensating module, configured to execute amplitude compensation processing on the deconvoluted data to obtain the upgoing wave data.

9. The apparatus according to claim 7, wherein the profile information generating unit comprises:
a depth domain amplitude value extracting module, configured to determine upgoing wave amplitude information of the depth domain on the basis of the upgoing wave data; and
a filtering module, configured to process the upgoing wave amplitude information on the basis of a preset multichannel filtering method to obtain the zero offset profile of the depth domain.

10. The apparatus according to claim 9, wherein the depth domain amplitude value extracting module is specifically configured to:
determine a plurality of preset output depth positions in the depth domain;
determine a second time window on the basis of the first arrival time information; and
process the upgoing wave data on the plurality of preset output depth positions on the basis of the second time window to obtain the upgoing wave amplitude information.

11. The apparatus according to claim 10, wherein the filtering module is specifically configured to:
extract the upgoing wave amplitude information to obtain a plurality of corresponding depth-domain data, wherein the upgoing wave amplitude information is in one-to-one correspondence to the plurality of preset output depth positions; and
process the plurality of depth-domain data on the basis of the preset multichannel filtering method to obtain the zero offset profile of the depth domain.

12. The apparatus according to claim 7, wherein the calibrating unit is specifically configured to:
determine the to-be-calibrated depth-domain profile;
determine a depth error between the zero offset profile and the to-be-calibrated depth-domain profile and a corresponding relationship of reflection characteristics; and
analyze the depth error and the corresponding relationship of the reflection characteristics to generate the corresponding calibration result.

13. The apparatus according to claim 7, comprising a memory and a processor, and a computer program stored in the memory and capable of operating on the processor, wherein the processor, when executing the computer program, implements the borehole seismic wavefield obtaining unit, the first arrival time obtaining unit, the preprocessing unit, the profile information generating unit and the calibrating unit.

14. A non-transitory computer readable storage medium, storing a computer program, wherein the program, when executed by a processor, implements the following steps:
obtaining vertical seismic profile (VSP) wavefield data of a depth domain from a borehole acquisition instrument;
determining first arrival time information on the basis of the VSP wavefield data;
processing the VSP wavefield data on the basis of a preset filtering method and the first arrival time information to obtain upgoing wave data;
generating a zero offset profile of the depth domain on the basis of the upgoing wave data; and
calibrating, on the basis of the zero offset profile, a depth-domain profile to be calibrated, so as to generate a corresponding calibration result, wherein the calibration result comprises depth accuracy evaluation information of the profile of the depth domain and corresponding correction suggestion information.

15. The non-transitory computer readable storage medium according to claim 14, wherein the preset filtering method comprises a median filtering method and a mean filtering method; and
processing the VSP wavefield data on the basis of a preset filtering method and the first arrival time information to obtain upgoing wave data comprises:
processing the VSP wavefield data on the basis of the median filtering method or the mean filtering method to determine a corresponding upgoing wave and downgoing wave;
determining a first time window on the basis of the first arrival time information;
processing the downgoing wave on the basis of the first time window to obtain a downgoing wavelet;
executing deconvolution processing on the upgoing wave in data after wavefield separation on the basis of the downgoing wavelet to obtain deconvoluted data; and
executing amplitude compensation processing on the deconvoluted data to obtain the upgoing wave data.

16. The non-transitory computer readable storage medium according to claim 14, wherein generating the zero offset profile of the depth domain on the basis of the upgoing wave data comprises:
determining upgoing wave amplitude information of the depth domain on the basis of the upgoing wave data; and
processing the upgoing wave amplitude information on the basis of a preset multichannel filtering method to obtain the zero offset profile of the depth domain.

17. The non-transitory computer readable storage medium according to claim 16, wherein determining the upgoing wave amplitude information of the depth domain on the basis of the upgoing wave data comprises:
determining a plurality of preset output depth positions in the depth domain;
determining a second time window on the basis of the first arrival time information; and
processing the upgoing wave data on the plurality of preset output depth positions on the basis of the second time window to obtain the upgoing wave amplitude information.

18. The non-transitory computer readable storage medium according to claim 17, wherein processing the upgoing wave amplitude information on the basis of the preset multichannel filtering method to obtain the zero offset profile of the depth domain comprises:
extracting the upgoing wave amplitude information to obtain a plurality of corresponding depth-domain data, wherein the upgoing wave amplitude information is in one-to-one correspondence to the plurality of preset output depth positions; and
processing the plurality of depth-domain data on the basis of the preset multichannel filtering method to obtain the zero offset profile of the depth domain.

19. The non-transitory computer readable storage medium according to claim 14, wherein calibrating, on the basis of the zero offset profile, a depth-domain profile to be calibrated, so as to generate a corresponding calibration result, comprises:
determining the to-be-calibrated depth-domain profile;
determining a depth error between the zero offset profile and the to-be-calibrated depth-domain profile and a corresponding relationship of reflection characteristics; and
analyzing the depth error and the corresponding relationship of the reflection characteristics to generate the corresponding calibration result.
